(19) United States
(12) Patent Application Publication
(10) Pub. No.: US 2011/0110084 A1
(43) Pub. Date: May 12, 2011

(54) LIGHTING APPARATUS

(76) Inventors: Kyu-Sik Moon, Gyeonggi-do (KR); Dae-Sik Moon, Gyeonggi-do (KR); Yong-Ho Kim, Incheon (KR)

(21) Appl. No.: 13/003,131

(22) PCT Filed: Jun. 30, 2009
(86) PCT No.: PCT/KR09/03537

§ 371 Date: Jan. 7, 2011

(30) Foreign Application Priority Data
Jul. 8, 2008 (KR) 20-2008-0009065

(51) Int. Cl. F21V 1/00

(52) U.S. Cl. 362/248

(57) ABSTRACT

A lighting apparatus may include a housing and an illuminating member. The housing may include sequentially stacked shades. Each of the shades may have a central portion and an edge portion extending from the central portion. The central portions of the shades may be stacked. The edge portions of the shades may have an annular shape. The edge portions of the shades may be arranged spaced apart from each other. The shades may include a material having a high thermal conductivity. The shades may include aluminum, copper, an alloy thereof, etc. The edge portions of the shades may function as heat dissipating fins for dissipating a heat in the illuminating member. The illuminating member may be installed at the housing.

### BACKGROUND

1. Field

Example embodiments relate to a lighting apparatus. More particularly, example embodiments relate to a lighting apparatus including a plurality of light emitting diodes having high brightness.

2. Description of the Related Art

Generally, a lighting apparatus using mercury or sodium may be used for a streetlight. However, because the lighting apparatus using the mercury or the sodium may have a high power consumption, a lighting apparatus using a light emitting diode (LED) having high brightness may recently be used for the streetlight.

However, the LED may generate high heat in operation. Thus, when the heat may not be dissipated from the lighting apparatus including the LED, a lifespan of the LED may be decreased. As a result, a cost for repairing the lighting apparatus may be remarkably increased.

Recently, various lighting apparatuss configured to overcome the above-mentioned problems may be developed. For example, a cooling structure such as a heat dissipating fin, a cooling fan, a coolant, etc., may be adapted to the lighting apparatus. Examples of the cooling structure may be disclosed in Korean Patent Laid-Open Publication Nos. 2007-97679, 2008-6979, 2007-97004, etc.

However, when the cooling fin may be located in a case of the lighting apparatus, a heat dissipation capacity may be low. Further, because the cooling fan or the coolant may cause a complicated structure, it may be difficult to apply the cooling fan or the coolant to the lighting apparatus. Furthermore, when a cooling air or the coolant may be forcedly circulated, costs for manufacturing and repairing the lighting apparatus may be greatly increased.

Particularly, the streetlight may be exposed to light of the sun. Therefore, an internal temperature of the streetlight may be highly increased, so that the lifespan of the LED may be reduced.

### SUMMARY

Example embodiments provide a lighting apparatus having improved heat dissipation and a simple structure.

According to example embodiments, there may be provided a lighting apparatus. The lighting apparatus may include a housing and an illuminating member. The housing may include sequentially stacked shades. Each of the shades may have a central portion and an edge portion extending from the central portion. The central portions of the shades may be stacked. The edge portions of the shades may have an annular shape. The edge portions of the shades may be arranged spaced apart from each other. The shades may include a material having a high thermal conductivity. The shades may include aluminum, copper, an alloy thereof, etc. The edge portions of the shades may function as heat dissipating fins for dissipating a heat in the illuminating member. The illuminating member may be installed at the housing.

In some example embodiments, the central portions of the shades may have a tubular shape. Further, the central portions of the shades may have a telescoped structure.

In some example embodiments, each of the central portions of the shades except for an uppermost shade may have an opened upper end and a closed lower end. Further, the central portions of the shades may have gradually increasing heights. The shades may be combined with each other using a fixing member such as a screw or a bolt fixed to the upper most shade through the closed ends.

In some example embodiments, the illuminating member may include a plurality of LEDs and a socket plate configured to receive the LEDs.

In some example embodiments, the socket plate may have a concave lower surface defined by a lower central surface and a slant edge surface of the socket plate. The LEDs may be installed in the concave lower surface. The LEDs may be installed at the lower central surface and the slant edge surface.

In some example embodiments, the edge portions of the shades may have a plurality of holes for dissipating the heat in the illuminating member.

In some example embodiments, the central portions of the shades may have vertically stacked plate shapes.

In some example embodiments, the edge portions of the shades may extend in different directions.

In some example embodiments, the lighting apparatus may further include a connecting member arranged on the central portion of the uppermost shade to connect the housing with a fixture.

In some example embodiments, the lighting apparatus may further include a cover configured to cover the illuminating member. The cover may include a light-transmitting material.

According to some example embodiments, the housing may be simply manufactured by a pressing process, a rolling process, etc. The housing having the heat-dissipating structure may have a light weight, so that a cost for manufacturing the lighting apparatus may be reduced. Further, the shades of the housing may increase a heat-dissipating area, so that a junction temperature and a heat resistance of the LEDs may be decreased to increase a lifespan of the LEDs. Furthermore, the lighting apparatus may have improved light distribution by controlling a slant angle of the concave lower surface on which the LEDs may be installed. As a result, the lighting apparatus may emit uniform light.

### BRIEF DESCRIPTION OF THE DRAWINGS

FIG. 1 is a cross-sectional view illustrating a lighting apparatus in accordance with in some example embodiments;

FIG. 2 is a side view illustrating the lighting apparatus in FIG. 1;

FIG. 3 is an exploded perspective view illustrating shades of a lighting apparatus in some example embodiments;

FIG. 4 is a cross-sectional view illustrating a lighting apparatus in accordance with in some example embodiments;

FIG. 5 is a top view illustrating the lighting apparatus in FIG. 4; and

FIG. 6 is a bottom view illustrating the lighting apparatus in FIG. 4.

### DETAILED DESCRIPTION OF EXAMPLE EMBODIMENTS

Various example embodiments will be described more fully hereinafter in which some example embodiments are shown. Example embodiments may, however, be embodied in many different forms and should not be construed as limited to the example embodiments set forth herein. Rather, these example embodiments are provided so that this disclosure will be thorough and complete, and will fully convey the scope of example embodiments to those skilled in the art.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are schematic illustrations of idealized example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

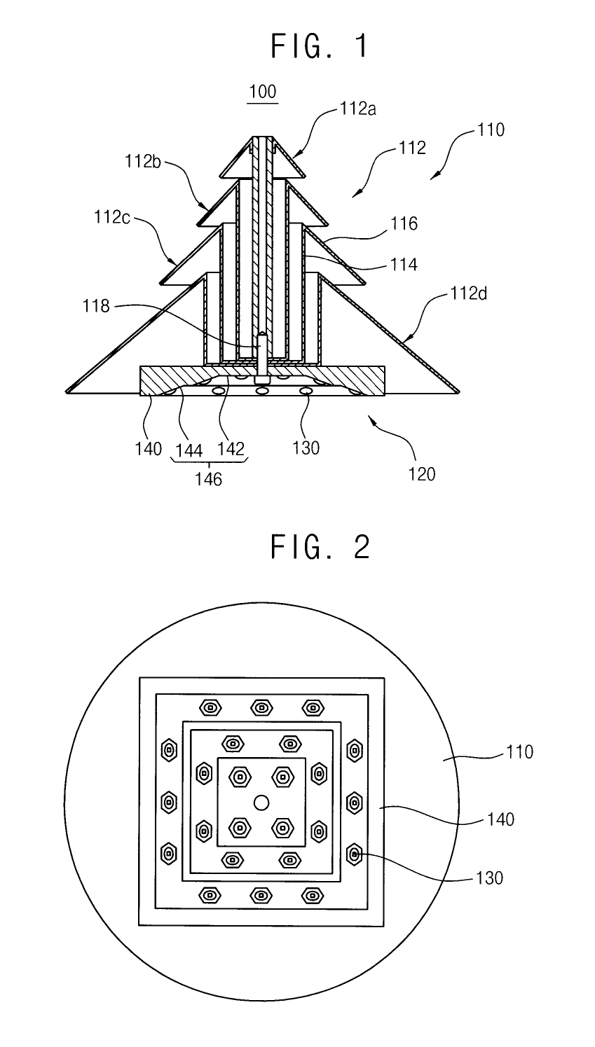

FIG. 1 is a cross-sectional view illustrating a lighting apparatus in accordance with in some example embodiments, and FIG. 2 is a side view illustrating the lighting apparatus in FIG. 1.

Referring to FIG. 1, a lighting apparatus 100 of this example embodiment may use LEDs 130. The lighting apparatus 100 may include a housing 110 and an illuminating member 120 installed at the housing 110. The illuminating member 120 may include the LEDs 130.

The housing 110 may include a plurality of shades 112. Each of the shades 112 may include a central portion 114 and an edge portion 116. The central portions 114 of the shades 112 may be vertically stacked. The edge portions 116 of the shades 112 may extend from the central portions 114. In some example embodiments, the edge portions 116 of the shades 112 may have an annular shape.

In some example embodiments, the central portions 114 of the shades 112 may have a tubular shape. Further, the central portions 114 of the shades 112 may have a telescope structure. For example, the central portions 114 of the shades 112 may have a cylindrical shape. The central portions 114 of the shades 112 may have gradually decreasing diameters in an upwardly vertical direction. The edge portions 116 of the shades 112 may outwardly extend from upper ends of the cylindrical central portions 114. Alternatively, the central portions 114 of the shades 112 may have an elliptical shape, a polygonal shape such as a quadrangle shape, a pentagonal shape, etc. Although the housing 110 may include the four shades 112 in drawings, the numbers of the shades 112 may not be restricted within a specific number.

Each of the central portions 114 of the shades 112b, 112c and 112d except for an uppermost shade 112a may have an opened upper end and a closed lower end. The closed lower ends of the shades 112b, 112c and 112d may be vertically stacked. The central portion 114 of the uppermost shade 112a may have an opened upper end and an opened lower end. Thus, the central portion 114 of the uppermost shade 112a may have a vertical hole. In some example embodiments, a threaded portion (not shown) may be formed on the opened upper end and the opened lower end of the central portion 114 of the uppermost shade 112a. A fixing member 118 may be threaded with the threaded portion on the opened lower end of the uppermost shade 112a through the opened lower ends of the shades 112b, 112c and 112d to connect the shades 112 with each other. The threaded portion on the opened upper end of the uppermost shade 112a may be used for connect the lighting apparatus 100 to a fixture (not shown). Alternatively, the shades 112 may be connected with each other by a welding, a soldering, etc.

In some example embodiments, the central portions 114 of the shades 112 may have gradually increasing heights in the upwardly vertical direction. The edge portions 116 of the shades 112 may outwardly extend from the upper ends of the central portions 114. Thus, the edge portions 116 of the shades 112 may be spaced apart from each other in the vertical direction.

Extension lengths of the edge portions 116 of the shades 112 may be gradually increased in a downwardly vertical direction. That is, the edge portions 116 of the shades 112 may have gradually increasing sizes in the downwardly vertical direction. Slant angles of the edge portions 116 of the shades 112 may be substantially equal to or different from each other. For example, the slant angles of the edge portions 116 of the shades 112 may be gradually decreased in the upwardly vertical direction. In some example embodiments, the edge portions 116 of the shades 112 may have a conical shape. The central portions 114 of the shades 112 may be spaced apart from each other in a horizontal direction.

The illuminating member 120 may be installed on a lower central surface of the lowermost shade 112d. The illuminating member 120 may include the LEDs 130 and a socket plate 140 configured to receive the LEDs 130. The socket plate 140 may be fixed to the housing 110 using a fixing member 118. In some example embodiments, the fixing member 118 may be fixed to the central portion 114 of the uppermost shade 112a through a central portion of the socket plate 140 and the central portions 114 of the shades 112b, 112c and 112d.

Referring to FIG. 2, the socket plate 140 may have a concave portion 146. The concave portion 146 may be formed at a lower surface of the socket plate 140. The concave portion 146 may be defined by a lower central surface 142 of the socket plate 140 and a slant inner surface 144 of the socket plate 140. Thus, the slant inner surface 144 may be placed around the lower central surface 142. The LEDs 130 may be installed in the concave portion 146. That is, the LEDs 130 may be installed on the lower central surface 142 and the slant inner surface 144. In some example embodiments, the inner surface 144 may have a slant angle of about 20° to about 40°. The slant inner surface 144 may function as to improve light distribution of the LEDs 130. Particularly, the slant inner surface 144 may function as to control a light distribution angle of the LEDs 130. Thus, light uniformity of the LEDs 130 may be controlled by adjusting the slant angle of the inner surface 144.

In some example embodiments, the slant inner surface 144 may have a two-stepped structure. Alternatively, the slant inner surface 144 may not have a stepped structure. Further, the slant inner surface 144 may have at least three-stepped structure. When the slant inner surface 144 may not have the stepped structure, the slant inner surface 144 may have a rounded shape to improve the light distribution of the lighting apparatus 100. When the slant inner surface 144 may have a multi-stepped structure, the slant inner surface 144 may have different slant angles.

In some example embodiments, the socket plate 140 may have a rectangular shape. Alternatively, the socket plate 140 may have a circular shape, an elliptical shape, a triangular shape, a pentagonal shape, a hexagonal shape, etc.

In some example embodiments, the LEDs 130 may be installed at the lowermost shade 112d of the housing 110 through the socket plate 140. Alternatively, the LEDs 130 may be directly installed at the housing 110. The socket plate 130 may have a flat lower surface.

The lighting apparatus 100 may further include a cover (not shown) for protecting the LEDs 130 in the socket plate 140. In some example embodiments, the cover may include a light-transmitting material to uniformly diffuse the light from the LEDs 130.

A light-reflecting layer (not shown) may be formed on the lower central surface 142 and the slant inner surface 144 in the concave portion 146 of the socket plate 140. The light-reflecting layer may reflect the light to improve light efficiency of the lighting apparatus 100. In some example embodiments, the light-reflecting layer may include a silver mirror layer. Alternatively, the light-reflecting layer may include other materials in place of the silver mirror layer.

According to this example embodiment, the edge portions 116 of the shades 112 in the housing 110 may function as cooling fins for dissipating the heat from the illuminating member 120. The housing 110 may have a large surface area due to the edge portions 116 of the shades 112 vertically spaced apart from each other and the central portions 114 of the shades 112 horizontally spaced apart from each other, so that the lighting apparatus 100 may have improved heat dissipating capacity. As a result, the LEDs 130 may have a low junction temperature and a low thermal resistance. Further, the lighting apparatus 100 may have a long lifespan.

Moreover, the shades 112 of the housing 110 may be formed by the pressing process or the rolling process. Thus, a cost for forming the housing 110 may be remarkably reduced.

Furthermore, when the lighting apparatus 100 may be used for a streetlight, the edge portions 116 of the shades 112 may function as a light-blocking plate for preventing the socket plate 140 and the central portions 114 of the shades 112 from being directly exposed to the light of the sun.

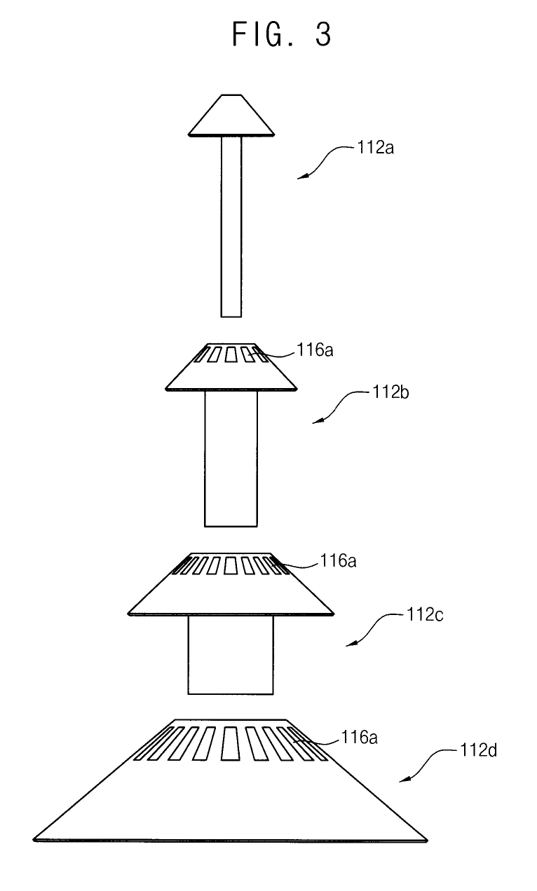

FIG. 3 is an exploded perspective view illustrating shades of a lighting apparatus in some example embodiments.

Referring to FIG. 3, the shades 112b, 112c and 112c of the housing 110 except for the uppermost shade 112a may have a plurality of holes 116a. In some example embodiments, the holes 116a may be formed through the edge portions of the shades 112b, 112c and 112d of the housing 110 in a circumferential direction. The holes 116a may function as to dissipate the heat from the LEDs 130.

In some example embodiments, the holes 116a formed through the edge portions of the shades 112b, 112c and 112d may function as ventilating holes. When the lighting apparatus 100 may be used in a streetlight, the holes 116a may improve the heat dissipation capacity of the lighting apparatus 100.

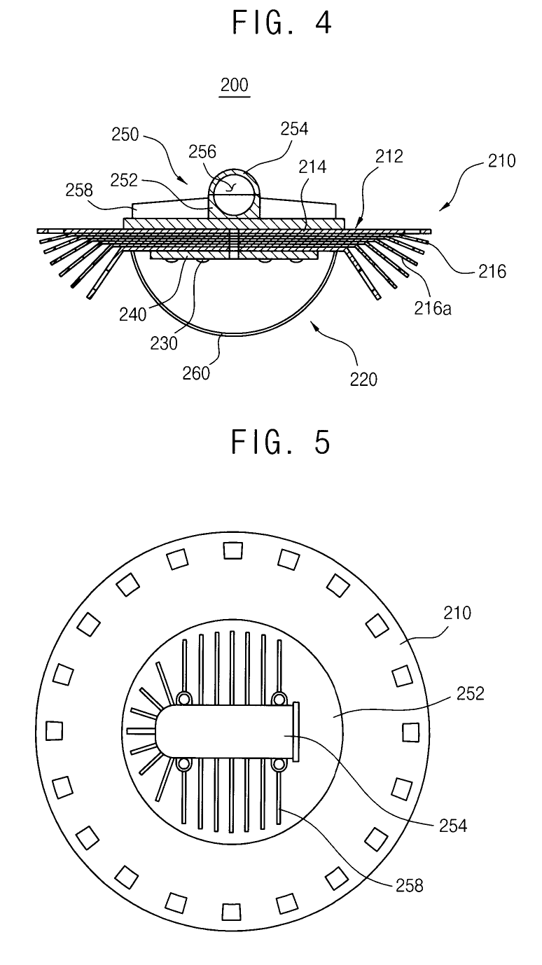

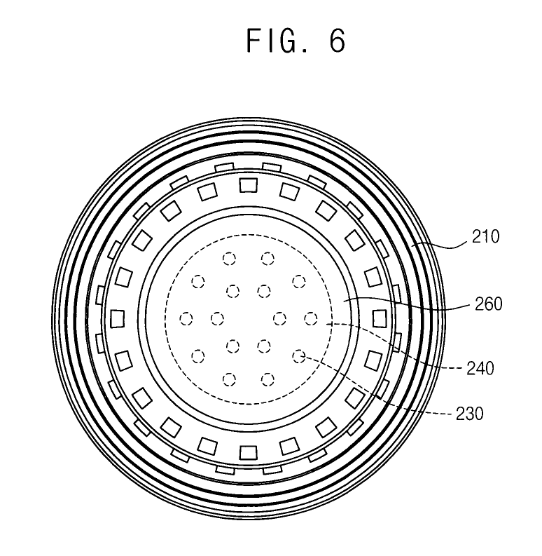

FIG. 4 is a cross-sectional view illustrating a lighting apparatus in accordance with in some example embodiments, FIG. 5 is a top view illustrating the lighting apparatus in FIG. 4, and FIG. 6 is a bottom view illustrating the lighting apparatus in FIG. 4.

Referring to FIGS. 4 to 6, a lighting apparatus 200 of this example embodiment may include a housing 210 and an illuminating member 220 installed at the housing 210. The housing 210 may include a plurality of shades 212. The illuminating member 220 may include the LEDs 230.

In some example embodiments, the housing 110 may include a plurality of the stacked shades 212. Each of the shades 212 may include a central portion 214 and an edge portion 216. The central portions 214 of the shades 212 may be vertically stacked. The edge portions 216 of the shades 212 may extend from the central portions 214. The edge portions 216 of the shades 212 may have an annular shape.

In some example embodiments, the central portions 214 of the shades 212 may have a plate shape. The edge portions 216 of the shades 212 may outwardly extend from the central portions 214 in different directions. Thus, the edge portions 212 of the shades 212 may be vertically stacked.

In some example embodiments, the edge portion 216 of the uppermost shade 212 may extend in the horizontal direction. The edge portions 216 of the shades 212 except for the uppermost shade 212 may slantly extend in the downward direction. The shades 212 except for the uppermost shade 212 may have gradually increasing slant angles in the downwardly vertical direction. Alternatively, the edge portion 216 of the uppermost shade 212 may have a downwardly slant angle.

In some example embodiments, the central portions 214 of the shades 212 may have an elliptical shape, a polygonal shape such as a quadrangle shape, a pentagonal shape, etc.

In some example embodiments, the central portions 214 of the shades 212 may have gradually increasing diameters in the upwardly vertical direction. Further, the edge portions 216 of the shades 212 may have substantially the same slant angle.

Alternatively, the central portions 214 of the shades 212 may have substantially the same diameter. Further, the edge portions 216 of the shades 212 may have gradually increasing slant angles in the downwardly vertical direction.

The illuminating member 220 may include the LEDs 230 and a socket plate 240 on a lower central surface of the lowermost shade 212. The socket plate 240 may have a flat lower surface. Alternatively, the socket plate 240 may have the lower surface in FIG. 1. In some example embodiments, the socket plate 240 may have a circular shape, an elliptical shape, a polygonal shape, etc. For example, the socket plate 240 may have a disc shape. Alternatively, the LEDs 230 may be directly installed at the lower surface of the lowermost shade 212.

In some example embodiments, a connecting member 250 may be arranged on an upper surface of the uppermost shade 212. The connecting member 250 may connect the housing 210 to a fixture (not shown). The connecting member 250 may include a lower block 252 and an upper block 254. A hole 256 may be formed between the lower block 252 and the upper block 254 to connect the connecting member 250 with the fixture. The lower block 252 and the upper block 254 may be combined with each other using a fixing member such as a bolt, a screw, etc. Particularly, a support bar of the fixture may be inserted into the hole 256 to combine the lower block 252 and the upper block 254 with each other, thereby fixing the housing 210 to the fixture.

In some example embodiments, the connecting member 250 may have a plurality of fins 258. The lower block 252 of the connecting member 250 may be fixed to the housing 210 using a bolt or a screw. Alternatively, the lower block 252 of the connecting member 250 may be fixed to the housing by a welding process, a soldering process, etc.

In some example embodiments, the shades 212 of the housing 210 may be connected to the connecting member 250 using a bolt or a screw. A fixing member (not shown) may be threaded with the lower block 252 of the connecting member 250 through the socket plate 240 and the shades 212.

The lighting apparatus 200 may further include a cover 260 for protecting the LEDs 230 in the socket plate 240. In some example embodiments, the cover 260 may include a light-transmitting material to uniformly diffuse the light from the LEDs 230.

In some example embodiments, the shades 212 of the housing 210, the connecting member 250 and the socket plate 240 may include a material having a high thermal conductivity to readily dissipate the heat from the LEDs 230. For example, the shades 212, the connecting member 250 and the socket plate 240 may include aluminum, copper, an alloy thereof, etc.

In some example embodiments, the edge portions 216 of the shades 212 may function as cooling fins for dissipating the heat from the illuminating member 220. The housing 210 may have a large surface area due to the edge portions 216 of the shades 212 vertically spaced apart from each other, so that the lighting apparatus 200 may have improved heat dissipating capacity. Further, when the lighting apparatus 200 may be used for a streetlight, the edge portions 216 of the shades 212 may function as a light-blocking plate for preventing the socket plate 240 and the central portions 214 of the shades 212 from being directly exposed to the light of the sun.

In some example embodiments, holes 216a may be formed through the edge portions 216 of the shades 212 in the circumferential direction. The holes 216a may function as to dissipate the heat from the LEDs 230. The holes 216a formed through the edge portions 216 of the shades 212 may function as ventilating holes. When the lighting apparatus 200 may be used in a streetlight, the holes 216a may improve the heat dissipation capacity of the lighting apparatus 200.

According to this example embodiment, the housing may be simply manufactured by a pressing process, a rolling process, etc using a thin plate. That is, the shade of the housing may be manufactured by the simple process. Further, the housing may have a light weight due to the thin plate. As a result, a cost for manufacturing the lighting apparatus may be remarkably reduced.

Moreover, the shades of the housing may be used as the fins and light blocking plates, so that the lighting apparatus may have improved heat dissipation capacity. Further, a junction temperature and a heat resistance of the LEDs may be decreased to increase a lifespan of the LEDs. Furthermore, the lighting apparatus may have improved light distribution by controlling a slant angle of the concave lower surface on which the LEDs may be installed. As a result, the lighting apparatus may emit uniform light.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims.

What is claimed is:

1. A lighting apparatus comprising:
a housing including a plurality of shades that has stacked central portions and annular edge portions extending from the central portions, the edge portions being spaced apart from each other; and
an illuminating member installed at the housing.

2. The lighting apparatus of claim 1, wherein the central portions of the shades have tubular shapes arranged in a telescoped structure.

3. The lighting apparatus of claim 2, wherein the central portions of the shades except for an uppermost shade have opened upper ends and closed lower ends, and the central portions of the shades have gradually increasing heights in an upwardly vertical direction.

4. The lighting apparatus of claim 1, wherein the lighting apparatus comprises;
a plurality of LEDs; and
a socket plate configured to receive the LEDs.

5. The lighting apparatus of claim 4, wherein the socket plate has a concave lower surface configured to receive the LEDs, and the concave lower surface is defined by a lower central surface and a slant inner surface located around the lower central surface.

6. The lighting apparatus of claim 1, wherein a plurality of holes for dissipating a heat from the illuminating member is formed through the edge portions of the shades.

7. The lighting apparatus of claim 1, wherein the central portions of the shades have vertically stacked plate shapes.

8. The lighting apparatus of claim 7, wherein the edge portions of the shades extend in different directions.

9. The lighting apparatus of claim 7, further comprising a connecting member arranged over an uppermost shade of the shades to connect the housing with a fixture.

10. The lighting apparatus of claim 1, further comprising a light-transmitting cover configured to cover the illuminating member.
